(19) United States
(12) Patent Application Publication
(10) Pub. No.: US 2020/0226675 A1
(43) Pub. Date: Jul. 16, 2020

(54) UTILIZING MACHINE LEARNING TO GENERATE PARAMETRIC DISTRIBUTIONS FOR DIGITAL BIDS IN A REAL-TIME DIGITAL BIDDING ENVIRONMENT

(71) Applicant: Adobe Inc., San Jose, CA (US)

(72) Inventors: Saayan Mitra, San Jose, CA (US); Aritra Ghosh, Amherst, MA (US); Somdeb Sarkhel, Dallas, TX (US); Jiatong Xie, Albany (CA)

(21) Appl. No.: 16/248,287

(22) Filed: Jan. 15, 2019

(51) Int. Cl. G06Q 30/08; G06N 20/00

(52) U.S. Cl. CPC G06Q 30/08; G06N 20/00

(57) ABSTRACT

The present disclosure relates to generating digital bids for providing digital content to remote client devices based on parametric bid distributions generated using a machine learning model (e.g., a mixture density network). For example, in response to identifying a digital bid request in a real-time bidding environment, the disclosed systems can utilize a trained parametric censored machine learning model to generate a parametric bid distribution. To illustrate, the disclosed systems can utilize a parametric censored, mixture density machine learning model to analyze bid request characteristics and generate a parametric, multi-modal distribution reflecting a plurality of parametric means, parametric variances, and combination weights. The disclosed systems can then utilize the parametric, multi-modal distribution to generate digital bids in response to the digital bid request in real-time (e.g., while a client device accesses digital assets corresponding to the bid request).

### BACKGROUND

Advancements in software and hardware platforms have led to a variety of improvements in systems that manage campaigns for generating, providing, and distributing digital content across client devices. For example, bidding systems can distribute digital content to remote client devices where digital content slots accessed by the remote client devices are auctioned in a real-time digital bidding environment. In particular, some bidding system can receive a digital bid request and generate bid distributions (e.g., via a non-parametric decision tree approach). The bidding system can then utilize the bid distribution to generate a digital bid for digital content slots. Some other bidding systems can generate (via a parametric approach) a predicted winning price in real time for a digital bid, albeit without a corresponding distribution.

Despite these advances, however, conventional bidding systems suffer from several technological shortcomings that result in inflexible, inaccurate, and inefficient operation. For example, conventional bidding systems are often inflexible in that they employ models that rigidly generate bid distributions based on unimodal distributions having a common (i.e., fixed) variance. The rigid models utilized by conventional bidding systems, however often fail to reflect real-world conditions. Moreover, bidding systems that generate a single bid estimates cannot assist in pacing or flexible bidding allocations (e.g., predicting results for other bids or generating digital bids for alternative real-time bidding strategies).

In addition to flexibility concerns, conventional bidding systems are also inaccurate. In particular, because conventional bidding systems typically generate bid distributions based on a common, fixed variance, such systems often generate inaccurate bid distributions. Consequently, conventional systems generate inaccurate digital bids for bid requests in distributing digital content to client devices. In addition, conventional bidding systems that consider point estimates of individual digital bids fail to identify optimal digital bids, particularly when generating digital bids for multiple auctions under a fixed budget. Indeed, conventional systems cannot determine an accurate optimal digital bid for a particular circumstance or strategy (e.g., a unique balance of utility versus cost) without a distribution of digital bids and corresponding success probabilities.

In addition to problems with inflexibility and inaccuracy, conventional bidding systems are also inefficient. In particular, many conventional systems employ models, such as decision trees, that require significant depth for accurate predictions and are time consuming to train. Consequently, conventional systems require significant resources (e.g., time, processing power, and computing memory) in order to fully train and apply the models.

These, along with additional problems and issues, exist with regard to conventional systems.

### SUMMARY

One or more embodiments described herein provide benefits and/or solve one or more of the foregoing or other problems in the art with systems, methods, and non-transitory computer readable storage media that generate digital bids for providing digital content to remote client devices based on parametric bid distributions generated using a machine learning model conditioned on bid features. In particular, the disclosed systems can utilize a fully parametric censored regression model as well as a mixture density network to provide accuracy and flexibility in modeling real-world data and generating digital bids. For example, in one or more embodiments, the disclosed systems train a machine learning model to generate parametric bid distributions using a mixture of observed data (e.g., data associated with past, successful bids) and partially-observed data (e.g., data associated with past, unsuccessful bids). In particular, the machine learning model can generate parametric bid distributions having a variance dependent upon specific characteristics of a corresponding digital bid request. In some embodiments, the disclosed systems further train the machine learning model to generate parametric, multimodal distributions using a mixture density network. After training the machine learning model, the disclosed systems can identify (e.g., receive) digital bid requests and utilize the trained machine learning model to generate a parametric, multi-modal bid distribution. Based on the parametric, multi-modal bid distribution, the disclosed systems can flexibly and accurately generate a digital bid for the digital bid request.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a parametric bid distribution system can operate in accordance with one or more embodiments;

FIG. 2A-2B illustrate a block diagram of a parametric censored machine learning model generating a parametric bid distribution in accordance with one or more embodiments;

FIG. 3 illustrates a block diagram of a parametric censored, mixture density machine learning model generating a parametric, multi-modal distribution in accordance with one or more embodiments;

FIGS. 4A-4B each illustrate a block diagram of training a parametric censored machine learning model to generate parametric bid distributions in accordance with one or more embodiments;

FIG. 5 illustrates a block diagram of the parametric bid distribution system generating a digital bid in response to identifying a digital bid request in accordance with one or more embodiments;

FIGS. 6A-6B each illustrate a bar graph reflecting experimental results regarding the effectiveness of the parametric bid distribution system in accordance with one or more embodiments;

FIG. 7 illustrates a table reflecting experimental results regarding the effectiveness of the parametric bid distribution system in accordance with one or more embodiments;

FIGS. 8A-8B illustrate plot graphs reflecting experimental results comparing the efficiency of a decision tree against the efficiency of the parametric bid distribution system in accordance with one or more embodiments;

FIG. 9 illustrates a table reflecting experimental results using a dataset from a popular demand side platform to test the effectiveness of the parametric bid distribution system in accordance with one or more embodiments;

FIG. 10 illustrates an example schematic diagram of a parametric bid distribution system in accordance with one or more embodiments;

FIG. 11 illustrates a flowchart of a series of acts of generating a digital bid in response to identifying a digital bid request in accordance with one or more embodiments; and

FIG. 12 illustrates a block diagram of an exemplary computing device in accordance with one or more embodiments.

### DETAILED DESCRIPTION

One or more embodiments described herein include a parametric bid distribution system that generates digital bids for providing digital content to remote client devices in a real-time digital bidding environment based on parametric distributions generated using a machine learning model. In particular, the parametric bid distribution system can utilize a heteroscedastic fully parametric censored regression model, as well as a mixture density network on censored data to accurately and flexibly model real-world performance in generating digital bid responses. For instance, the parametric bid distribution system can train a machine learning model to utilize censored regression to generate parametric bid distributions that provide a probability of success for different bids. The parametric bid distribution system can then identify digital bid requests for providing digital content to content slots associated with digital assets accessed by remote client devices. For each digital bid request, the parametric bid distribution system can generate a digital bid based on a parametric bid distribution generated by the trained machine learning model. In one or more embodiments, the machine learning model generates multi-modal, parametric distributions that flexibly and accurately reflect a mixture of different variances and modalities specific to the characteristics of a particular bid request.

To provide an example, in one or more embodiments, the parametric bid distribution system can train a parametric censored machine learning model using training bid requests, training bids, and corresponding training bid results. In particular, the parametric bid distribution can train the parametric censored machine learning model to generate parametric bid distributions, where the variance of each parametric bid distribution is based on characteristics of the corresponding bid request. The parametric bid distribution system can then identify a digital bid request for providing digital content to a remote client device accessing a digital asset via a remote server. While the remote client device continues to access the digital asset, the parametric bid distribution system can utilize the trained parametric censored machine learning model to generate a parametric bid distribution. Based on the generated parametric bid request, the system can then generate a digital bid for providing the digital content to the remote client device. In one or more embodiments, the parametric censored machine learning model includes a parametric censored, mixture density machine learning model that generates parametric, multi-modal distributions.

As just mentioned, in one or more embodiments, the parametric bid distribution system utilizes a parametric censored machine learning model to generate a parametric bid distribution having a parametric variance that depends on a digital bid request. In particular, the parametric variance can depend on the bid request characteristics of the digital bid request. In other words, the parametric censored machine learning model can parameterize the variance so that the value of the variance is dependent upon the bid request characteristics. Consequently, the parametric censored machine learning model can generate—for a first digital bid request—a first parametric bid distribution having a first parametric variance and—for a second digital bid request—a second parametric bid distribution having a second parametric variance. The value of the second parametric variance can have a value that is different than the value of the first parametric variance based on the differences between the characteristics of the first digital bid request and the second digital bid request.

Additionally, as mentioned above, in some embodiments, the parametric censored machine learning model includes a parametric censored, mixture density machine learning model trained to generate parametric, multi-modal distributions. In particular, the parametric censored, mixture density machine learning model can generate a plurality of parametric variances, a plurality of parametric means, and a plurality of mixture weights. The parametric bid distribution system can combine the parametric variances, parametric means, and mixture weights to generate a parametric, multi-modal distribution.

Similar to the parametric variances, the values of the parametric means and the mixture weights of the parametric, multi-modal distributions can also depend on the bid request characteristics of the particular bid request. In other words, the parametric censored, mixture density machine learning model can parameterize the variances, the means, and the mixture weights so the respective value of each depends on the bid request characteristics. Consequently, the values of the parametric variances, the parametric means, and the mixture weights can vary from one digital bid request to another.

As further mentioned above, the parametric bid distribution system can generate a digital bid based on the parametric bid distribution generated by the parametric censored machine learning model. In one or more embodiments, the parametric bid distribution system generates the digital bid by using the parametric bid distribution to balance the cost (i.e., the amount paid if the bid is successful) and the utility (i.e., the benefit of a successful bid) of the digital bid. In some embodiments, the parametric bid distribution system utilizes the parametric bid distribution to identify a balance of probability of return for reduced cost consistent with campaign parameters and generates the digital bid accordingly.

The parametric bid distribution system provides several advantages over conventional systems. For example, the parametric bid distribution system improves flexibility. In particular, by generating parametric bid distributions having a variance that depends on the characteristics of a bid request, the parametric bid distribution system relaxes the assumption that winning bids are drawn from bid distributions having a common (i.e., fixed) variance. Further, by generating parametric, multi-modal distributions having a plurality of parametric variances, a plurality of parametric means, and a plurality of mixture weights, the parametric bid distribution system relaxes the assumption that winning bids are drawn from unimodal distributions. Consequently, the parametric bid distribution system can flexibly generate parametric bid distributions that model complex real-time bidding scenarios. Furthermore, the parametric bid distribution system can flexibly generate digital bids to account for budget pacing or other variable bidding allocations. For example, the parametric bid distribution system can predict the results at a variety of prices and generate digital bids for different real-time bidding strategies (e.g., consider cost and utility to generate bids at significant price reductions with only minimal reductions in success rate to improve overall return). This flexibility leads to optimized bidding, improved key performance indicators, and better targeting of digital content to client devices.

Additionally, by generating parametric bid distributions that have a parametric variance dependent upon the characteristics of a digital bid request (including generating parametric, multi-modal distributions), the parametric bid distribution system can generate bid distributions that more accurately model real-world conditions and the probability of successfully placing a digital bid for a digital bid request. In particular, the generated parametric bid distributions can provide a more accurate probability of success for each possible bid in a real-time bidding environment. Further, the parametric bid distribution system can identify optimal digital bids depending on particular campaign objectives. For instance, the parametric bid distribution system can identify optimal bids for a particular campaign objective, even where the optimal bid does not necessarily maximize expected success for each bid (e.g., a reduced probability of success for a significant reduction in cost to improve long term expected return).

Further, the parametric bid distribution system improves efficiency. In particular, by training a parametric censored machine learning model (or a parametric censored, mixture density machine learning model) to generate parametric bid distributions, the parametric bid distribution system reduces many processing requirements for training conventional systems. Consequently, the parametric bid distribution system avoids using the excessive amount of time, processing power, and memory required by more demanding models.

As illustrated by the foregoing discussion, the present disclosure utilizes a variety of terms to describe features and benefits of the parametric bid distribution system. Additional detail is now provided regarding the meaning of these terms. For example, as used herein, the term “digital bid request” refers to a digital communication corresponding to an opportunity to provide digital content and requesting a response. In particular, a digital bid request refers to a request for digital data indicating a bid for providing digital content to a remote client device. For example, a digital bid request can refer to a request sent from an ad exchange to a demand side platform associated with a digital content provider, requesting a bid to provide a thirty second video advertisement to be played before a video accessed through a digital asset (e.g., a social media site).

In one or more embodiments, a digital bid request includes one or more digital bid request characteristics. As used herein, a “bid request characteristic” or “digital bid request characteristic” refers to a feature that describes a digital bid request. In particular, a bid request characteristic can include a categorical description of an aspect of the digital bid request, which can include an aspect of a user accessing a digital asset and triggering the digital bid request. Examples of a bid request characteristic can include, but are not limited to, a type of remote client device to which the digital content will be provided (e.g., mobile device, desktop, tablet, etc.), a user gender, a user age, a publisher, publisher verticals, or a type of digital auction.

Additionally, as used herein, the term “digital bid” refers to a digital communication providing digital information corresponding to a bid request. In particular, a digital bid can refer to a response to a digital bid request, providing a bid for providing digital content to a remote client device. To illustrate, a digital bid can refer to a bid provided to an ad exchange from a demand side platform associated with a digital content provider, in response to a digital bid request, to provide a thirty second video advertisement to be played before a video accessed through a publisher website. More specifically, a digital bid can include a dollar amount to be paid by the digital content provider for the ability to provide the digital content to the remote client device. Additionally, or alternatively, a digital bid can include a commitment to provide another resource, such as a service.

Further, as used herein, the term “digital asset” refers a digital platform through which digital content can be presented. For example, a digital asset can include a website, an application on a client device, or a video provided by a publisher through a network.

Additionally, as used herein, the term “parametric bid distribution” refers to a function indicating a predicted result across a range of bids based on a bid request characteristic or parameter (e.g., a distribution that changes based on variations in bid request characteristics). In particular, a parametric bid distribution can include a Gaussian distribution that provides, across a range of bids, a probability of success for each bid (i.e., a probability of winning a corresponding digital auction). For example, a parametric bid distribution can include a bid distribution having a variance that depends on the bid request characteristics of the corresponding digital bid request. In one or more embodiments, a parametric bid distribution includes a “parametric, multi-modal distribution” which includes a mixture of various distributions (i.e., mixture densities) combined into one distribution. In particular, a parametric, multi-modal distribution can include a plurality of parametric variances, a plurality of parametric means, and a plurality of mixture weights. In one or more embodiments, the value for each of the parametric variances, parametric means, and mixture weights can depend on the bid request characteristics of the corresponding digital bid request.

As used herein, the term “parametric variance” refers to a measure of deviation within a distribution that is based on a bid request characteristic. In particular, a parametric variance can refer to a parameterized value representing the deviation, where the parameterized value depends on one or more features. For example, a parametric variance can include a parameterized standard deviation of a distribution or a parameterized square of the standard deviation dependent upon (e.g., varies based on) one or more bid request characteristics.

Similarly, as used herein, the term “parametric mean” refers to a measure of an average value within a distribution that is a based on a bid request characteristic. In particular, a parametric mean can refer to a parameterized value representing the average, where the parameterized value varies based on different bid request characteristics. For example, the parametric mean can include a parameterized arithmetic mean dependent upon one or more bid request characteristics.

As used herein, a “machine learning model” refers to a computer representation that can be tuned (e.g., trained) based on inputs to approximate unknown functions. In particular, the term “machine-learning model” can include a model that utilizes algorithms to learn from, and make predictions on, known data by analyzing the known data to learn to generate outputs that reflect patterns and attributes of the known data. For instance, a machine-learning model can include but is not limited to a neural network (e.g., a convolutional neural network, recurrent neural network or other deep learning network), support vector learning, Bayesian network, regression-based model (e.g., censored regression), or a combination thereof In one or more embodiments, a machine learning model can refer to a “parametric censored machine learning model” that generates parametric bid distributions. In some embodiments, a parametric censored machine learning model comprises a “parametric censored, mixture density machine learning model” that generates parametric, multi-modal distributions. Additional detail regarding parametric censored machine learning model and parametric censored, mixture density machine learning model is provided below.

As mentioned, a machine learning model can include a neural network. As used herein, the term “neural network” refers to a machine learning model that can be tuned (e.g., trained) based on inputs to approximate unknown functions. In particular, the term neural network can include a model of interconnected artificial neurons (organized in layers) that communicate and learn to approximate complex functions and generate outputs based on a plurality of inputs provided to the model. In addition, a neural network is an algorithm (or set of algorithms) that implements deep learning techniques that utilize a set of algorithms to model high-level abstractions in data. The term neural network can include a mixture density network. As used herein, the term “mixture density network” refers to a neural network that models a target variable as a mixture of distributions, in which the distributions and the corresponding mixture weights are parametrized by functions of the inputs.

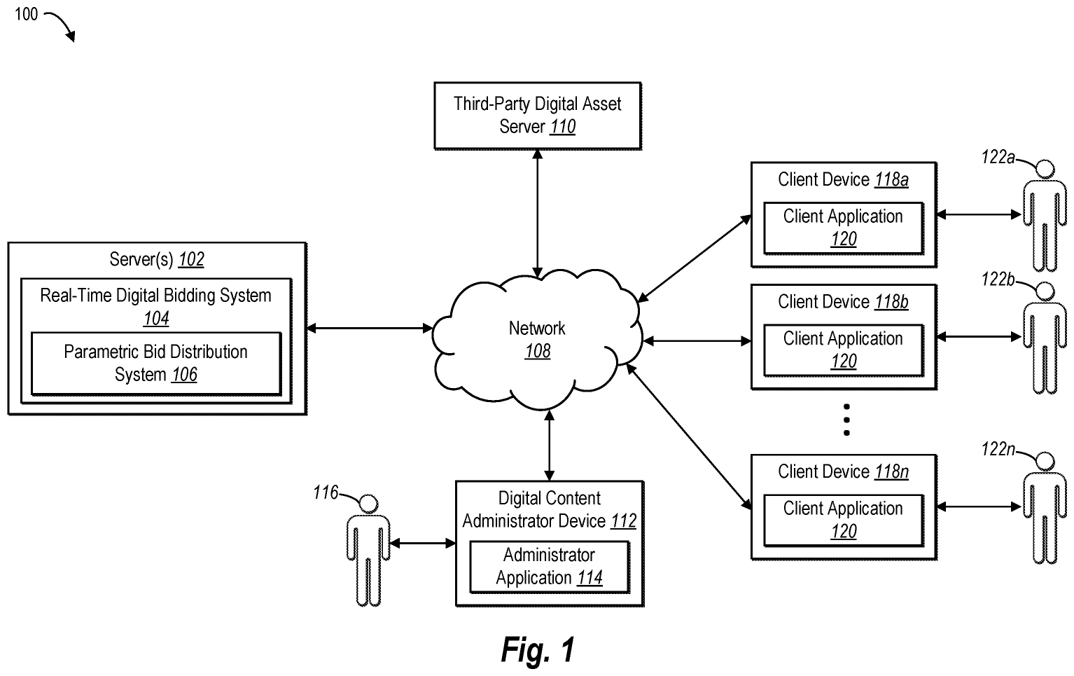

Additional detail regarding the parametric bid distribution system will now be provided with reference to the figures. For example, FIG. 1 illustrates a schematic diagram of an exemplary system environment (“environment”) 100 in which a parametric bid distribution system 106 can be implemented. As illustrated in FIG. 1, the environment 100 can include a server(s) 102, a network 108, a third-party digital asset server 110 (e.g., a content server and/or exchange server, such as an ad exchange server, hosting digital auctions), a digital content administrator device 112, a digital content administrator 116, client devices 118a-118n, and users 122a-122n.

Although the environment 100 of FIG. 1 is depicted as having a particular number of components, the environment 100 can have any number of additional or alternative components (e.g., any number of servers, third-party digital asset servers, digital content administrator devices, client devices, or other components in communication with the parametric bid distribution system 106 via the network 108). Similarly, although FIG. 1 illustrates a particular arrangement of the server(s) 102, the network 108, the third-party digital asset server 110, the digital content administrator device 112, the digital content administrator 116, the client devices 118a-118n, and the users 122a-122n, various additional arrangements are possible.

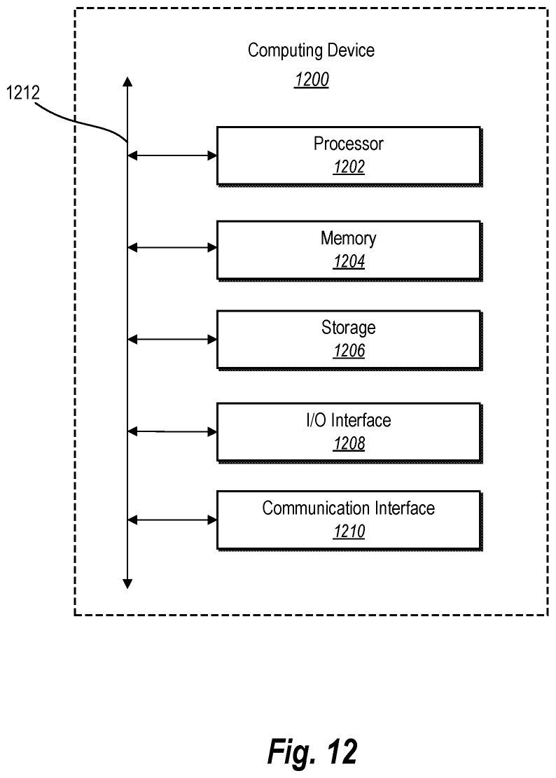

The server(s) 102, the network 108, the third-party digital asset server 110, the digital content administrator device 112, and the client devices 118a-118n may be communicatively coupled with each other either directly or indirectly (e.g., through the network 108 discussed in greater detail below in relation to FIG. 12). Moreover, the server(s) 102, the third-party digital asset server 110, the digital content administrator device 112, and the client devices 118a-118n may include a computing device (including one or more computing devices as discussed in greater detail below with relation to FIG. 12).

As mentioned above, the environment 100 includes the server(s) 102. The server(s) 102 can generate, store, receive, and/or transmit data, including data regarding digital content campaign constraints, digital bid requests, digital bids, or digital content. For example, the server(s) 102 can receive a digital bid request from the third-party digital asset server 110 and transmit a digital bid back to the third-party digital asset server 110. If the digital bid is successful, the server(s) 102 can transmit digital content to the third-party digital asset server 110. In one or more embodiments, the server(s) 102 comprises a data server. The server(s) 102 can also comprise a communication server or a web-hosting server. In one or more embodiments, the server(s) 102 receives only a portion of the digital bid request (i.e., a subset of bid request characteristics corresponding to the digital bid request) and retrieves the other portion (i.e., the remaining bid request characteristics) from stored data.

As shown in FIG. 1, the server(s) 102 can include a real-time digital bidding system 104. In particular, the real-time digital bidding system 104 can perform digital bidding functions in real time. For example, the real-time digital bidding system 104 can receive a digital bid request from the third-party digital asset server 110. The real-time digital bidding system 104 can subsequently provide the digital bid request to the parametric bid distribution system 106 and prepare the resulting digital bid for communication back to the third-party digital asset server 110. The real-time digital bidding system 104 can prepare digital content for communication to the third-party digital asset server 110 (e.g., where the digital bid is successful).

Additionally, the server(s) 102 can include the parametric bid distribution system 106. In particular, in one or more embodiments, the parametric bid distribution system 106 uses the server(s) 102 to generate digital bids in response to digital bid requests. For example, the parametric bid distribution system 106 can use the server(s) 102 to identify (e.g., receive) a digital bid request and generate a digital bid.

For example, in one or more embodiments, the server(s) 102 can identify a digital bid request for providing digital content to a remote client device accessing a digital asset via a remote server. In response to identifying the digital bid request, and while the remote client device is accessing the digital asset via the remote server, the server(s) 102 can utilize a parametric censored machine learning model to generate a parametric bid distribution that includes a parametric variance based on the digital bid request (i.e., based on bid request characteristics of the digital bid request). The server(s) 102 can then generate a digital bid for providing the digital content to the remote client device based on the parametric bid distribution.

As shown in FIG. 1, the environment 100 also includes the third-party digital asset server 110. In one or more embodiments, the third-party digital asset server 110 provides access to a digital asset to the client devices 118a-118n. For example, the third-party digital asset server 110 can host and provide access to a website (e.g., a social network website). In some embodiments, the third-party digital asset server 110 hosts a digital asset accessible through an application (e.g., the client application 120, such as a social networking application or gaming application) hosted on the client devices 118a-118n.

Additionally (or alternatively), the third-party digital asset server 110 can operate as a digital content exchange (e.g., an ad exchange hosting a digital auction) that interacts with the server(s) 102 to exchange digital bid requests, digital bids, and digital content. For example, in response to a remote client device (e.g., one of the client devices 118a-118n) accessing the digital asset, the third-party digital asset server 110 can provide a digital bid request to the server(s) 102 and, in return, receive a digital bid. Additionally, the third-party digital asset server 110 can provide digital bid requests to, and receives digital bids from, servers associated with one or more other digital content providers interested in providing digital content to the remote client device (while the remote client device accesses digital assets, such as a webpage). If the third-party digital asset server 110 determines that the digital bid received from the server(s) 102 is successful (e.g., the highest bid), the third-party digital asset server 110 can notify the server(s) 102, identify the digital content to provide to the remote client device, and then provide the digital content to the client device via the digital asset (in real-time, while the remote client device continues to access the digital asset). This process of identifying a client device accessing a digital asset, conducting a digital bid, and providing digital content is performed in less than a second (usually in milliseconds), and thus cannot be performed manually.

In one or more embodiments, the client devices 118a-118n include computer devices that allow users of the devices (e.g., the users 122a-122n) to access a digital asset provided by the third-party digital asset server 110. For example, the client devices 118a-118n can include smartphones, tablets, desktop computers, laptop computers, or other electronic devices. The client devices 118a-118n can include one or more applications (e.g., the client application 120) that allow the users 122a-122n to access the digital asset provided by the third-party digital asset server 110. For example, the client application 120 can include a software application installed on the client devices 118a-118n. Additionally, or alternatively, the client application 120 can include a software application hosted on the server(s) 102, which may be accessed by the client devices 118a-118n through another application, such as a web browser.

In one or more embodiments, the digital content administrator device 112 includes a computer device that allows a user of the device (e.g., the digital content administrator 116) to provide digital content (e.g., a digital advertisement to be placed in/along with multimedia or text content in a website) and digital content campaign parameters/constraints to the parametric bid distribution system 106. For example, the digital content administrator device 112 can include a smartphone, a tablet, a desktop computer, a laptop computer, or other electronic device. The digital content administrator device can include one or more applications (e.g., the administrator application 114) that allows the digital content administrator 116 to submit digital content and digital content campaign parameters (e.g., campaign budget, campaign duration or time, campaign objectives, and/or campaign target audiences,). For example, the administrator application 114 can include a software application installed on the digital content administrator device 112. Additionally, or alternatively, the administrator application 114 can include a software application hosted on the server(s) 102, which may be accessed by the digital content administrator device 112 through another application, such as a browser.

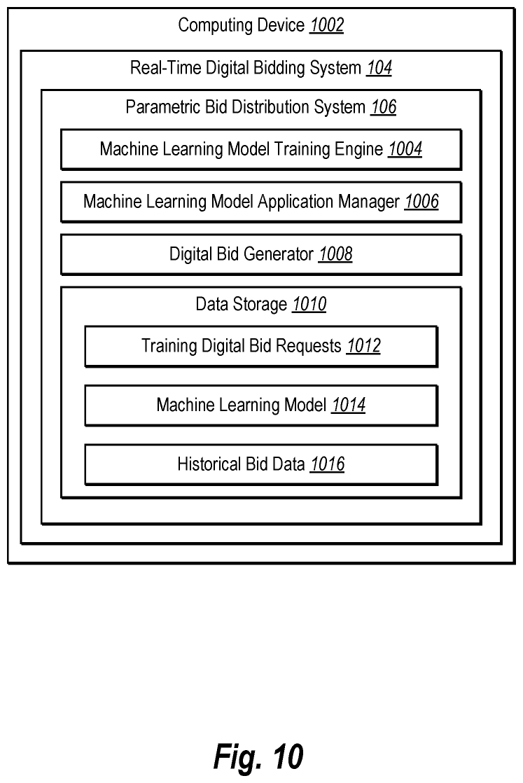

The parametric bid distribution system 106 can be implemented in whole, or in part, by the individual elements of the environment 100. Indeed, although FIG. 1 illustrates the parametric bid distribution system 106 implemented with regards to the server(s) 102, different components of the parametric bid distribution system 106 can be implemented in any of the components of the environment 100, such as the digital content administrator device 112 and/or the third-party digital asset server 110. The components of the parametric bid distribution system 106 will be discussed in more detail with regard to FIG. 10 below.

As mentioned above, in one or more embodiments, the parametric bid distribution system 106 generates digital bids in light of campaign objectives to optimize utility relative to cost.

To provide an illustrative example in relation to the environment 100 of FIG. 1, the parametric bid distribution system 106 identifies a digital bid request (from the third-party digital asset server 110). Identifying the digital bid request includes identifying one or more bid request characteristics (e.g., characteristics of the client device 118a or user 122a accessing a digital asset via the third-party digital asset server 110).

After identifying a digital bid request (broadly referred to as the i^{th} digital bid request), the parametric bid distribution system 106 generates a feature vector Xᵢ, which captures all of the corresponding bid request characteristics. For example, in one or more embodiments, the parametric bid distribution system encodes the bid request characteristics into the feature vector Xᵢ (using binary). Using the feature vector Xᵢ, the parametric bid distribution system 106 generates a digital bid. If the parametric bid distribution system 106 submits the winning bid, then the digital content administrator 116 pays the winning price. Formally, the winning price is represented as:

wᵢ=max{bᵢ^{Pub}, bᵢ^{DSP}^{₁}, bᵢ^{DSP}^{₂}, . . . , bᵢ^{DSP}^{_{K}}} (1)

In equation 1, bᵢ^{Pub} represents the floor price set by the third-party digital asset server 110 and bᵢ^{DSP}^{₁}, bᵢ^{DSP}^{₂}, . . . , bᵢ^{DSP}^{_{K}} represent the bidding prices received from the entities participating in the digital auction, referred to as “demand side platforms” or “DSPs.” The parametric bid distribution system 106 represents an exemplary implementation of a DSP operating in behalf of the digital content administrator 116.

The parametric bid distribution system 106 operates to implement an optimal bidding strategy. In particular, the parametric bid distribution system 106 operates to maximize some utility (i.e., a benefit from placing the winning bid, such as a click, a conversion, an impression, etc.) using bidding strategy [symbol] and with budget [symbol] . Indeed, the parametric bid distribution system 106 implements the following optimization problem where costᵢ is the price paid by the digital content administrator 116 if the parametric bid distribution system 106 submits the winning bid:

$${max}_{𝒜} {\sum }_{i} {u}_{i} s . t . {\sum }_{i} {cost}_{i} \leq ℬ \qquad ( 2 )$$

The variables of equation 2 are unknown before the digital auction is concluded, therefore, the parametric bid distribution system 106 determines the expected cost and the expected utility using the information corresponding to the digital bid request (e.g., in real-time, while the client device 118a accesses digital assets). Equation 2 then becomes:

$${max}_{𝒜} {\sum }_{i} E [ {u}_{i} \vert {X}_{i} , {b}_{i} ] s . t . {\sum }_{i} E [ {cost}_{i} \vert {X}_{i ′} {b}_{i} ] \leq ℬ \qquad ( 3 )$$

In equation 3, μᵢ is a random variable conditioned on Xᵢ and bᵢ. For the digital bid request Xᵢ, the winning price distribution is represented as p_{w}(wᵢ, Xᵢ) and its cumulative distribution function is represented as F_{w}(wᵢ, Xᵢ). For a bid bᵢ, the parametric bid distribution system 106 determines the expected cost and the expected utility using the following:

$$\begin{matrix}E [ {cost}_{i} \vert {X}_{i} , {b}_{i} ] = \frac{{\int }_{0}^{{b}_{i}} {wp}_{w} ( {w}_{i} = w \vert {X}_{i} ) dw}{{\int }_{0}^{{b}_{i}} {p}_{w} ( {w}_{i} = w \vert {X}_{i} ) dw} & ( 4 ) \\ E [ {u}_{i} \vert {X}_{i} , {b}_{i} ] = {F}_{w} ( {w}_{i} = {b}_{i} \vert {X}_{i} ) E [ {u}_{i} \vert {X}_{i} ] & ( 5 )\end{matrix}$$

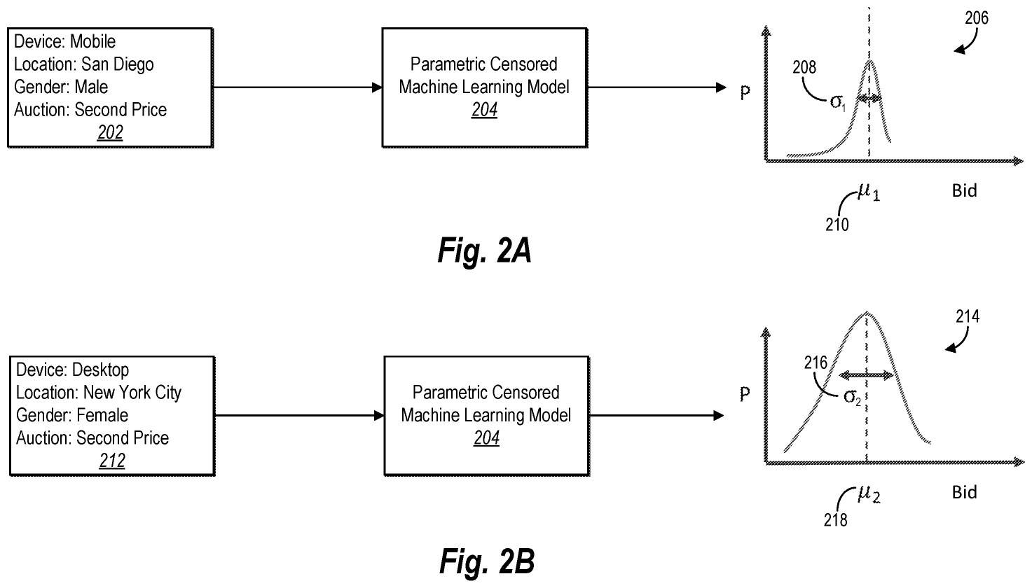

As mentioned above, in selecting digital bids pursuant to the foregoing equations, the parametric bid distribution system 106 can generate and apply a parametric bid distribution. In particular, the parametric bid distribution system 106 can utilize a parametric censored machined learning model to generate a parametric bid distribution in response to identifying a digital bid request for providing digital content to a remote client device. The parametric bid distribution system 106 can then use the parametric bid distribution to generate a digital bid for providing the digital content. For example, FIGS. 2A-2B illustrate block diagrams for utilizing a parametric censored machine learning model to generate parametric bid distributions in response to identifying digital bid requests in accordance with one or more embodiments. In particular, FIGS. 2A-2B illustrate parametric bid distributions having different parametric variances due to differences in the bid request characteristics corresponding to the digital bid requests. In particular, the parametric bid distributions each include a probability density function where the y-axis provides a probability density.

For example, FIG. 2A illustrates the parametric censored machine learning model 204 utilizing a set of bid request characteristics 202 corresponding to a digital bid request to generate a parametric bid distribution 206. As seen in FIG. 2A, the set of bid request characteristics 202 includes a characteristic that refers to the type of client device used to access the digital asset through which the digital content will be presented if the digital bid is successful. Further, the set of bid request characteristics 202 includes characteristics that describe the location of the client device (i.e., the location of the user utilizing the client device to access the digital asset), the gender of the user associated with the client device, and the type of digital auction being held. It should be noted that, though the set of bid request characteristics 202 indicate that the parametric bid distribution system 106 is participating in a “second price” digital auction, the parametric bid distribution system 106 can participate in any type of digital auction (e.g., a first price sealed auction, an English auction, a reverse auction, etc.). Further, the set of bid request characteristics 202 shown in FIG. 2, illustrate a small set of characteristics for the purpose of simplicity; however, some embodiments involve tens, hundreds, or even thousands of bid request characteristics.

As previously mentioned, the parametric bid distribution system 106 can identify the bid request characteristics included in the set of bid request characteristics 202. In one or more embodiments, identifying the bid request characteristics includes receiving the bid request characteristics (e.g., from the third-party digital asset server 110, acting as an ad exchange). In some embodiments, the parametric bid distribution system 106 receives only a subset of bid request characteristics and retrieves the remaining bid request characteristics from stored data. Indeed, the parametric bid distribution system 106 can use one or more received bid request characteristics to locate and retrieve the remaining bid request characteristics within data storage. To illustrate, in some embodiments, the set of bid request characteristics 202 includes a device ID (e.g., an IP address) corresponding to the remote client device accessing the digital asset. The parametric bid distribution system 106 can use the device ID to locate and retrieve one or more additional bid request characteristics (e.g., those included within the set of bid requests characteristics 202) mapped to the device ID within data storage.

As illustrated in FIG. 2A, the parametric censored machine learning model 204 can use the set of bid request characteristics 202 to generate the parametric bid distribution 206. In particular, the parametric censored machine learning model 204 can generate the parametric variance 208 (represented as σ₁) for the parametric bid distribution 206 based on the set of bid request characteristics 202. In one or more embodiments, the parametric censored machine learning model 204 also generates the mean 210 based on the set of bid request characteristics 202. For example, the parametric censored machine learning model 204 can generate the mean 210 based on an assumed linear relationship between the mean 210 and the feature vector Xᵢ.

Moreover, FIG. 2B illustrates the parametric censored machine learning model 204 utilizing a set of bid request characteristics 212 corresponding to a different digital bid request to generate the parametric bid distribution 214. As shown in FIG. 2B, the set of bid request characteristics 212 includes characteristics that are different than those included within the set of bid request characteristics 202. Consequently, the parametric bid distribution 214 differs from the parametric bid distribution 206. In particular, the parametric bid distribution 214 comprises a parametric variance 216 (represented as σ₂) and a mean 218 (represented as μ₂) that are based on the set of bid request characteristics 212 and differ from the parametric variance 208 and mean 210, respectively. By generating parametric bid distributions having variances that are based on the corresponding bid request characteristics, the parametric bid distribution system 106 can more flexibly and more accurately model the probability of a successful bid based on the different bid request characteristics of different corresponding digital bid requests.

As discussed above, conventional systems often utilize a static, uniform, or fixed variance. Thus, in contrast to FIGS. 2A-2B, conventional systems can generate distributions that have a uniform deviation, even when bid request characteristics change. Thus, under conventional systems the standard deviation (σ) would not change between the circumstances illustrated in FIGS. 2A, 2B.

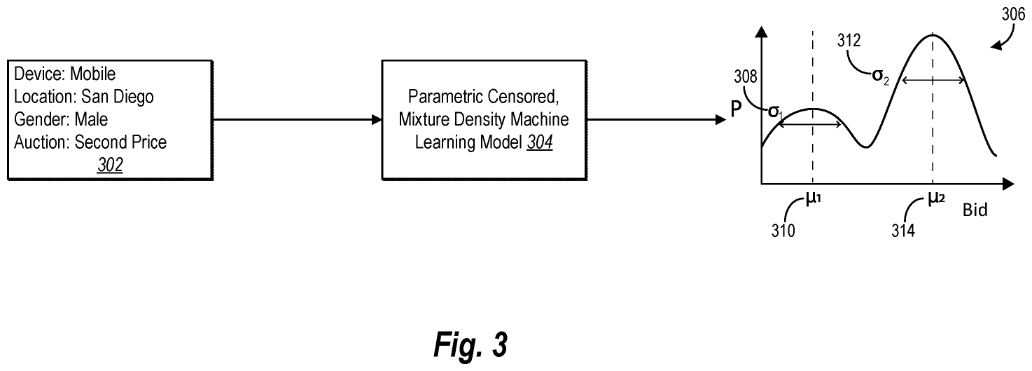

As mentioned above, the parametric censored machine learning model can include a parametric censored, mixture density machine learning model trained to generate parametric, multi-modal distributions. FIG. 3 illustrates a block diagram for utilizing a parametric censored, mixture density machine learning model in accordance with one or more embodiments. In particular, FIG. 3 illustrates the parametric censored, mixture density machine learning model 304 utilizing a set of bid request characteristics 302 to generate a parametric, multi-modal distribution 306.

As can be seen, the set of bid request characteristics 302 includes the same characteristics as the set of bid request characteristics 202 of FIG. 2A. Consequently, a comparison of the parametric bid distribution 206 of FIG. 2A and the parametric, multi-modal distribution 306 of FIG. 3 reveals that the parametric bid distribution system 106 provides additional flexibility and accuracy when the parametric machine learning model includes a parametric censored, mixture density machine learning model.

As shown in FIG. 3, the parametric censored, mixture density machine learning model 304 generates the parametric, multi-modal distribution 306, which includes two distributions combined into one, multi-modal distribution. For example, the parametric, multi-modal distribution 306 includes a first parametric variance 308 (represented as σ₁) and a first parametric mean 310 (represented as μ₁) for a first distribution, and further includes a second parametric variance 312 (represented as μ₂) and a second parametric mean 314 (represented as μ₂) for a second distribution. In one or more embodiments, the parametric censored, mixture density machine learning model 304 generates the parametric, multi-modal distribution 306 by generating the first and second distributions (e.g., generating the parametric variance and parametric mean of each distribution) and combining the distributions using mixture weights corresponding to each distribution.

In one or more embodiments, the parametric, multi-modal distribution 306 can include a combination of any number of distributions, resulting in a corresponding number of parametric variances and parametric means. For example, the parametric bid distribution system 106 can train the parametric censored, mixture density machine learning model 304 to generate a specific number of distributions that are combined into the parametric, multi-modal distribution 306. For example, the parametric bid distribution system 106 can determine a number of distributions that optimizes the parametric, multi-modal distribution 306. To illustrate, the parametric bid distribution system 106 can employ an estimator, such as an Akaike Information Criterion or a Bayes Information Criterion to determine the optimal number of distributions. In one or more embodiments, however, the parametric bid distribution system 106 trains the parametric censored, mixture density machine learning model 304 to generate parametric, multi-modal distributions having a pre-selected number of distributions (e.g., four distributions).

In one or more embodiments, the parametric variance and parametric mean of each distribution has a different value than the parametric variance and parametric mean of every other distribution, respectively. For example, as shown in FIG. 3, the first parametric variance 308 has a different value than the second parametric variance 312, and the first parametric mean 310 has a different value than the second parametric mean 314. Indeed, the parametric variances generated by the parametric censored, mixture density machine learning model 304 can vary within a given parametric, multi-modal distribution and can further vary between different parametric, multi-modal distributions. In some embodiments, however, the parametric variance of a distribution can have the same value as the parametric variance, respectively, of one or more other distributions.

As just mentioned, the parametric bid distribution system 306 generates the parametric means 310, 314 and parametric variances 308, 312 based on the bid request characteristics 302. Thus, similar to FIGS. 2A- 2B, the parametric means 310, 314 and the parametric variances 308, 312 will change in response to different bid request characteristics. Accordingly, the parametric censored, mixture density machine learning model 304 generates a plurality of means, variances, and weights that each vary depending on the bid request characteristics identified by the parametric bid distribution system 306.

Thus, by generating parametric, multi-modal distributions, the parametric bid distribution system 106 can more accurately model the complexities associated with digital bid requests. In particular, the probability of success for a particular bid request may not be properly modeled using a unimodal distribution. By accurately modeling the probability of success using a parametric, multi-modal distribution, the parametric bid distribution system 106 can generate bids based on an accurate probability of success reflected in the distribution.

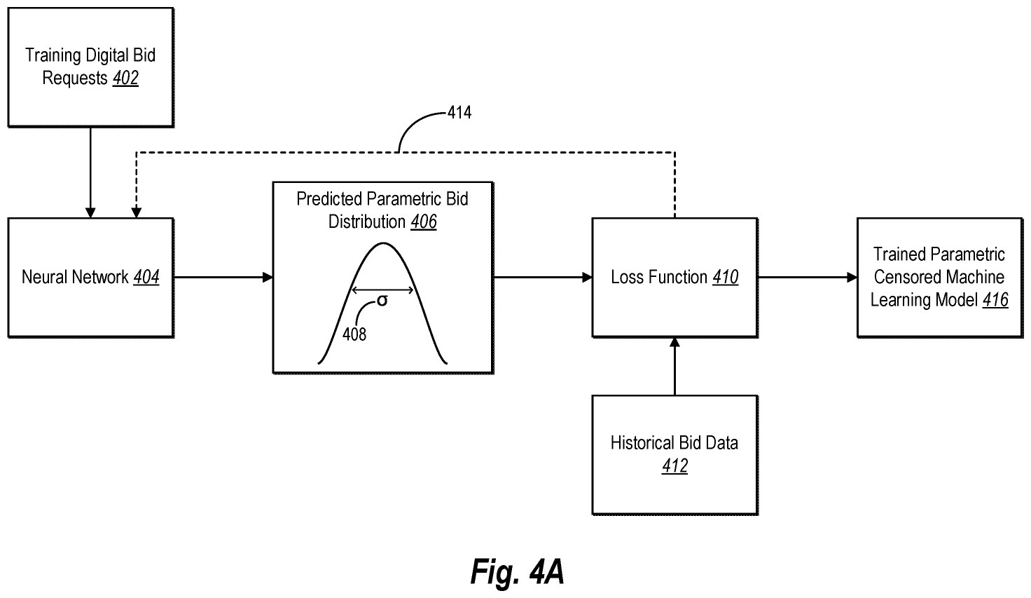

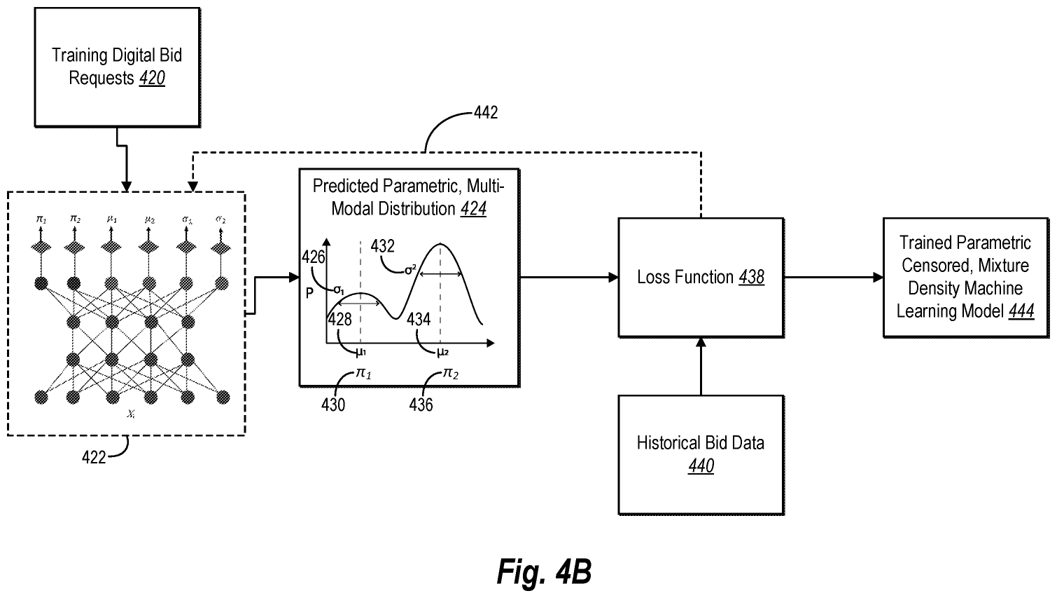

In one or more embodiments, the parametric censored machine learning model includes a neural network. In particular, the parametric bid distribution system 106 trains a neural network (or alternative machine learning model) to generate parametric bid distributions. FIG. 4A illustrates the parametric bid distribution system 106 training a parametric censored machine learning model having a neural network architecture to generate parametric bid distributions. FIG. 4B illustrates the parametric bid distribution system 106 training a parametric censored, mixture density machine learning model having a neural network architecture to generate parametric, multi-modal distributions.

As shown in FIG. 4A, the parametric bid distribution system 106 provides training digital bid requests 402 to a neural network 404. In one or more embodiments, the training digital bid requests 402 include past digital bid requests upon which a digital bid has been placed by or on behalf of (e.g., by the real-time digital bidding system 104) the corresponding digital content administrator. The training digital bid requests 402 can include past digital bid requests for which the digital content administrator has placed a winning digital bid as well as those for which the digital content administrator has placed a losing digital bid.

For each iteration of training, the neural network 404 analyzes a training digital bid request from the training digital bid requests 402 and generates a predicted parametric bid distribution 406. The predicted parametric bid distribution 406 provides a predicted probability of success for each possible bid that can be placed for the particular digital bid request. As seen in FIG. 4A, the predicted parametric bid distribution 406 includes a predicted parametric variance 408. For example, in one or more embodiments, the neural network 404 generates a value for the predicted parametric variance 408 based on the analyzed training digital bid request.

The parametric bid distribution system 106 then provides the predicted parametric bid distribution 406 to the loss function 410. The loss function 410 determines the loss (i.e., error) resulting from the neural network 404 based on the difference between an estimated value (i.e., the predicted parametric bid distribution 406) and the historical bid data 412. In one or more embodiments, the parametric bid distribution system 106 then back propagates the determined loss to the neural network 404 (as indicated by the dashed line 414) to modify its parameters. Consequently, with each iteration of training, the parametric bid distribution system 106 gradually increases the accuracy of the neural network 404 (e.g., through gradient descent, such as Adam Gradient Descent or LBFGS). As shown, the parametric bid distribution system 106 can thus generate the trained parametric censored machine learning model 416. More detail regarding the analysis used in training the neural network 404 (or alternative machine learning model), including the loss function 410, will now be provided.

In some embodiments, the parametric bid distribution system 106 trains the neural network 404 using censored regression, because the data upon which the regression is based does not always reflect a winning bid. In particular, the historical bid data 412 contains past bid data corresponding to each training digital bid request of the training digital bid requests 402 (i.e., real-time bidding results). In other words, the historical bid data 412 includes data corresponding to bids placed for each training digital bid request by or on behalf of the digital content administrator. However, the historical bid data 412 does not include data corresponding to any bids placed by or on behalf of other digital content administrators. Consequently, the data included in the historical bid data 412 only reflects a winning bid when the bid placed by or on behalf of the corresponding digital content administrator was successful. Otherwise, the data reflects a losing bid and only represents a lower bound for the true winning bid, which must have been higher than the bid placed by the corresponding digital content administrator. Therefore, the parametric bid distribution system 106 trains the neural network 404 using data reflective of both winning and losing bids (i.e., censored data).

Under censored regression, the estimated random variable is represented as yᵢ and the value of yᵢ is determined using the following equation where ϵᵢ represents the noise term and is independent and identically distributed (i.i.d.) from [symbol] (0, σ²) to yᵢ˜ [symbol] (β^{T}Xᵢ, σ²):

yᵢ=β^{T}Xᵢ+ϵᵢ (6)

A variety of distributions (e.g., a Gumbel distribution) can be used when using censored regression. Further, the linear link function can be replaced with any non-linear function. Thus, yᵢ can be parameterized using the following where ƒ can be any continuous differentiable function:

yᵢ=ƒ(β, Xᵢ)+ϵᵢ (7)

Because the winning price is known where a digital bid placed by or on behalf of the digital content provider was successful, the likelihood of winning is represented by the probability density function of equation 8 shown below. In equation 8, ϕ represents the probability density function of the standard normal [symbol] (0,1). Further, because the parametric bid distribution system 106 utilizes discrete winning prices in one or more embodiments, the term Pr(yᵢ=wᵢ) as provided in equation 8 can be viewed as the same as Pr(wᵢ−1)<yᵢ<(wᵢ+1).

$$Pr ( {y}_{i} = {w}_{i} ) = \frac{1}{σ} φ ( \frac{{w}_{i} - {β}^{T} {X}_{i}}{σ} ) \qquad ( 8 )$$

Because the winning price is unknown where the digital bid placed by or on behalf of the digital content provider was unsuccessful, the corresponding probability density function is unknown. However, because the bidding price represents a lower bound on the winning price, the probability that bid bᵢ will lose can be computed using equation 9 presented below. In equation 9, Φ represents cumulative distribution function for the standard normal distribution.

$$Pr ( {y}_{i} > {b}_{i} ) = Pr ( {ϵ}_{i} < {β}^{T} {X}_{i} - {b}_{i} ) = Φ ( \frac{{β}^{T} {X}_{i} - {b}_{i}}{σ} ) \qquad ( 9 )$$

Taking log of the density for winning auctions [symbol] and the log-probability for losing auctions [symbol] , the following loss function can be used in determining the value of the parameters β and σ:

$${β}^{*} , {σ}^{*} = arg {min}_{β , σ > 0} {\sum }_{i ∈ 𝒲} - log ( \frac{1}{σ} ϕ ( \frac{{w}_{i} - {β}^{T} {X}_{i}}{σ} ) ) + {\sum }_{i ∈ ℒ} - log ( Φ ( \frac{{β}^{T} {X}_{i} - {b}_{i}}{σ} ) ) \qquad ( 10 )$$

Thus, censored regression can be used to determine how to properly model a bid distribution. The parametric bid distribution system 106 improves the censored regression approach, however, by relaxing the general assumption that the noise (or error) follows a normal distribution with fixed variance. As mentioned above, this assumption causes inaccuracies where the noise does not truly follow a fixed variance normal distribution. Therefore, the parametric bid distribution system 106 relaxes this assumption by parameterizing the variance so that each parametric bid distribution includes a variance that is based on the digital bid request (i.e., based on the characteristics of the digital bid request). Specifically, the parametric bid distribution system 106 assumes that the noise term ϵᵢ comes from [symbol] (0, σᵢ²) where:

σᵢ=exp(α^{T}Xᵢ) (11)

In one or more embodiments, the parametric bid distribution system 106 parameterizes α^{T}Xᵢ with any linear function. Using equation 11 to modify equation 8, the likelihood for winning becomes:

$$Pr ( {y}_{i} = {w}_{i} ) = \frac{1}{exp ( {α}^{T} {X}_{i} )} φ ( \frac{{w}_{i} - {β}^{T} {X}_{i}}{exp ( {α}^{T} {X}_{i} )} ) \qquad ( 12 )$$

In equation 12, yᵢ is the predicted random variable from distribution [symbol] (β^{T}Xᵢ, exp(α^{T}Xᵢ)²) and ϕ still represents the probability density function of [symbol] (0,1). Because the variance has been parameterized, ϵᵢ˜ [symbol] (0, exp(α^{T}Xᵢ) are not i.i.d. samples. Using equation 11 to modify equation 9, the likelihood for losing based on the lower bound (i.e., the bidding price bᵢ) becomes:

$$Pr ( {y}_{i} > {b}_{i} ) = P ( {∈}_{i} < {β}^{T} {X}_{i} - {b}_{i} ) = Φ ( \frac{{β}^{T} {X}_{i} - {b}_{i}}{exp ( {α}^{T} {X}_{i} )} ) \qquad ( 13 )$$

Thus, based on equations 12 and 13, the loss function provided by equation 10 becomes:

$${β}^{*} , {α}^{*} = arg {min}_{β , α} {\sum }_{i ∈ 𝒲} - log ( \frac{1}{exp ( {α}^{T} {X}_{i} )} ϕ ( \frac{{w}_{i} - {β}^{T} {X}_{i}}{exp ( {α}^{T} {X}_{i} )} ) ) + {\sum }_{i ∈ ℒ} - log ( Φ ( \frac{{β}^{T} {X}_{i} - {b}_{i}}{exp ( {α}^{T} {X}_{i} )} ) ) \qquad ( 14 )$$

Thus, in one or more embodiments, the parametric bid distribution system 106 utilizes equation 14 as the loss function 410 of FIG. 4A to implement censored regression in training the neural network 404 (or alternative machine learning models). In equation 14, the first summation term represents a comparison of winning bid training data with the predicted parametric bid distribution 406. In particular, the first summation term represents a measure of loss corresponding to data from the historical bid data 412 corresponding to historical winning bids and the predicted parametric bid distribution 406. These historical winning bids represent the winning price of their respective digital auctions. The second summation term represents a comparison of losing bid training data with the predicted parametric bid distribution 406. In particular, the second summation term represents a measure of loss corresponding to data from the historical bid data 412 corresponding to historical losing bids and the predicted parametric bid distribution 406. Unlike the historical winning bids, these historical losing bids do not represent the winning price of their respective digital auction; rather, they represent a lower bound for the winning price. Thus, using equation 14, the parametric bid distribution system 106 can determine the error in the estimated value (e.g., the estimated value generated by the neural network or alternative machine learning models). Consequently, the parametric bid distribution system 106 can use equation 14 to facilitate modifying the parameters of the neural network 404 and eventually producing the trained parametric censored machine learning model 416 (or alternative machine learning model).

In one or more embodiments, the parametric bid distribution system 106 further improves the censored regression approach by additionally relaxing the assumption that the winning price comes from a unimodal distribution. In particular, the parametric bid distribution system 106 can train a parametric censored, mixture density machine learning model to generate parametric, multi-modal distributions. FIG. 4B illustrates the parametric bid distribution system 106 training a parametric censored, mixture density machine learning model 422 having a mixture density network architecture in accordance with one or more embodiments.

For each iteration of training, the parametric bid distribution system 106 provides a training digital bid request from the training digital bid requests 420 to the parametric censored, mixture density machine learning model 422. In particular, the parametric censored, mixture density machine learning model 422 analyzes the feature vector Xᵢ corresponding to the training digital bid request and produces a plurality of parametric variances (represented as σ), a plurality of parametric means (represented as μ), and a plurality of mixture weights (represented as π). Though FIG. 4B illustrates the mixture density network having a plurality of hidden layers, some embodiments involve only a single hidden layer or no hidden layers.

Each parametric variance, parametric mean, and mixture weight corresponds to a particular predicted distribution. The parametric censored, mixture density machine learning model 422 utilizes the plurality of mixture weights to combine the separate predicted distributions into one predicted distribution—the predicted parametric, multi-modal distribution 424. As an illustration, the predicted parametric, multi-modal distribution 424 includes a first predicted parametric variance 426, a first predicted parametric mean 428, and a first predicted mixture weight 430 for a first predicted distribution as well as a second predicted parametric variance 432, a second predicted parametric mean 434, and a second predicted mixture weight 436 for a second predicted distribution. In one or more embodiments, however, the parametric censored, mixture density machine learning model 422 can generate any number of predicted parametric means, predicted parametric variances, and predicted mixture weights for any number of predicted distributions.

The parametric bid distribution system 106 then provides the predicted parametric, multi-modal distribution 424 to the loss function 438. The loss function 438 determines the loss (i.e., error) resulting from the parametric censored, mixture density machine learning model 422 based on the difference between an estimated value (i.e., the predicted parametric, multi-modal distribution 424) and the historical bid data 440. In one or more embodiments, the parametric bid distribution system 106 then back propagates the determined loss to the parametric censored, mixture density machine learning model 422 (as indicated by the dashed line 442) to modify its parameters. Consequently, with each iteration of training, the parametric bid distribution system 106 gradually increases the accuracy of the parametric censored, mixture density machine learning model 422 (e.g., through gradient descent). As shown, the parametric bid distribution system 106 can thus generate the trained parametric censored, mixture density machine learning model 444. More detail regarding the analysis used in training the parametric censored, mixture density machine learning model 422, including the loss function 438, will now be provided.

The parametric bid distribution system 106 derives the parametric censored, mixture density machine learning model 422 from a Gaussian Mixture Model (GMM). For example, using the GMM, the parametric bid distribution system 106 represents the estimated random variable as yᵢ, which consists of K Gaussian densities and has the following probability density function:

p(yᵢ=wᵢ)=Σₖ₌₁^{K}πₖ(Xᵢ)N(wᵢ; μₖ(Xᵢ), σₖ²(Xᵢ)) (15)

In equation 15, πₖ(X), μₖ(X), and σₖ(X) are the mixture weight, parametric mean, and parametric variance for the k^{th} mixture density (i.e., distribution) respectively where k∈(1, . . . , K). To model the censored regression problem as a mixture model, the parametric bid distribution system 106 uses the GMM to formulate the parametric mean with a linear function. Further, the parametric bid distribution system 106 uses the GMM to model the logarithm of the parametric variance as a linear function to impose positivity of σ. The parametric bid distribution system 106 further uses the GMM to impose a similar positivity constraint on the mixture weights. Thus, the parametric bid distribution system 106 can determine the parametric mean, the parametric variance, and the mixture weight using equations 16, 17, and 18 respectively.

$$\begin{matrix}{μ}_{k} ( {X}_{i} ) = {β}_{μ , k}^{T} {X}_{i} & ( 16 ) \\ {σ}_{k} ( {X}_{i} ) = exp ( {β}_{σ , k}^{T} {X}_{i} ) & ( 17 ) \\ {π}_{k} ( {X}_{i} ) = \frac{exp ( {β}_{π , k}^{T} {x}_{i} )}{{\sum }_{j = 1}^{K} exp ( {β}_{π , j}^{T} {x}_{i} )} & ( 18 )\end{matrix}$$

The parametric bid distribution system 106 further generalizes the GMM, and thus defines the parametric censored, mixture density machine learning model 422 by parameterizing πₖ(Xᵢ), μₖ(Xᵢ), and σₖ(Xᵢ) with a deep neural network. In one or more embodiments, the parametric censored, mixture density machine learning model 422 uses a Gaussian mixture density network. In particular, the parametric censored, mixture density machine learning model 422 combines mixture models with neural networks. The output activation layer consists of 3K nodes (z_{i,k} for i∈{μ, σ, π} and k∈(1, . . . , K). The parametric censored, mixture density machine learning model 422 uses z_{μ,k}, and z_{σ, k}, and z_{π, k} to retrieve the parametric mean, parametric variance, and mixture weight for the k^{th} density. Thus, equations 16, 17, and 18 become:

$$\begin{matrix}{μ}_{k} ( {X}_{i} ) = {z}_{μ , k} ( {X}_{i} ) & ( 19 ) \\ {σ}_{k} ( {X}_{i} ) = exp ( {z}_{σ , k} ( {X}_{i} ) ) & ( 20 ) \\ {π}_{k} ( {X}_{i} ) = \frac{exp ( {z}_{π , k} ( {X}_{i} ) )}{{\sum }_{j = 1}^{K} exp ( {z}_{π , j} ( {X}_{i} ) )} & ( 21 )\end{matrix}$$

Using the likelihood defined in equation 15, for winning bids, the parametric censored, mixture density machine learning model 422 defines the corresponding negative log-likelihood for all winning bids using equation 22 below where ϕ is the probability density function of [symbol] (0,1).

$${\sum }_{i ∈ 𝒲} - log ( {\sum }_{k = 1}^{K} \frac{{π}_{k} ( {X}_{i} )}{{σ}_{k} ( {X}_{i} )} φ ( \frac{{w}_{i} - {μ}_{k} ( {X}_{i} )}{{σ}_{k} ( {X}_{i} )} ) ) \qquad ( 22 )$$

For losing bids, the parametric censored, mixture density machine learning model 422 can determine the likelihood of losing based on the lower bound using equation 23. The negative log-probability of all the losing auctions from the mixture density is then represented by equation 24. In both equations 23 and 24, Φ represents the cumulative distribution function of [symbol] (0,1).

$$\begin{matrix}Pr ( {y}_{i} > {b}_{i} ) = {\sum }_{k = 1}^{K} {π}_{k} ( {X}_{i} ) Φ ( \frac{{μ}_{k} ( {X}_{i} ) - {b}_{i}}{{σ}_{k} ( {X}_{i} )} ) & ( 23 ) \\ {\sum }_{i ∈ ℒ} - log ( {\sum }_{k = 1}^{K} {π}_{k} ( {X}_{i} ) Φ ( \frac{{μ}_{k} ( {X}_{i} ) - {b}_{i}}{{σ}_{k} ( {X}_{i} )} ) ) & ( 24 )\end{matrix}$$

Combining equations 22 and 24 provides the following loss function for the censored data where [symbol] represents the parameters of the parametric censored, mixture density machine learning model 422:

$${ℳ}^{*} = arg {min}_{ℳ} {\sum }_{i ∈ ℒ} - log ( {\sum }_{k = 1}^{K} {π}_{k} ( {X}_{i} ) Φ ( \frac{{μ}_{k} ( {X}_{i} ) - {b}_{i}}{{σ}_{k} ( {X}_{i} )} ) ) + {\sum }_{i ∈ 𝒲} - log ( {\sum }_{k = 1}^{K} \frac{{π}_{k} ( {X}_{i} )}{{σ}_{k} ( {X}_{i} )} ϕ ( \frac{{w}_{i} - {μ}_{k} ( {X}_{i} )}{{σ}_{k} ( {X}_{i} )} ) ) \qquad ( 25 )$$

In equation 25, the first summation term represents a comparison of losing bid training data with the predicted parametric, multi-modal distribution 424. In particular, the first summation term represents a measure of loss corresponding to data from the historical bid data 440 corresponding to historical losing bids and the predicted parametric, multi-modal distribution. These historical losing bids do not represent a winning price for their respective digital auction; rather, they represent a lower bound for the winning price. The second summation term represents a comparison of winning bid training data with the predicted parametric, multi-modal distribution 424. In particular, the second summation term represents a measure of loss corresponding to data from the historical bid data 440 corresponding to historical winning bids and the predicted parametric, multi-modal distribution 424. Unlike the historical losing bids, the historical winning bids do represent the winning price for their respective digital auction. Thus, using equation 25, the parametric bid distribution system 106 can determine the error in the estimated value generated by the parametric censored, mixture density machine learning model 422. Moreover, the parametric bid distribution system 106 can use equation 25 to facilitate modifying the parameters of the parametric censored, mixture density machine learning model 422 and eventually producing the trained parametric censored, mixture density machine learning model 444.

Thus, the parametric bid distribution system 106 can train a parametric censored machine learning model to generate parametric bid distributions in response to receiving digital bid requests. The algorithms and acts described with reference to FIGS. 4A-4B can comprise the corresponding structure for performing a step for training a parametric censored machine learning model to generate parametric bid distributions for digital bid requests. Additionally, the neural network architecture described in relation to FIG. 4A and the mixture density network architecture described in relation to FIG. 4B can comprise the corresponding structure for performing a step for training a parametric censored machine learning model to generate parametric bid distributions for digital bid requests.

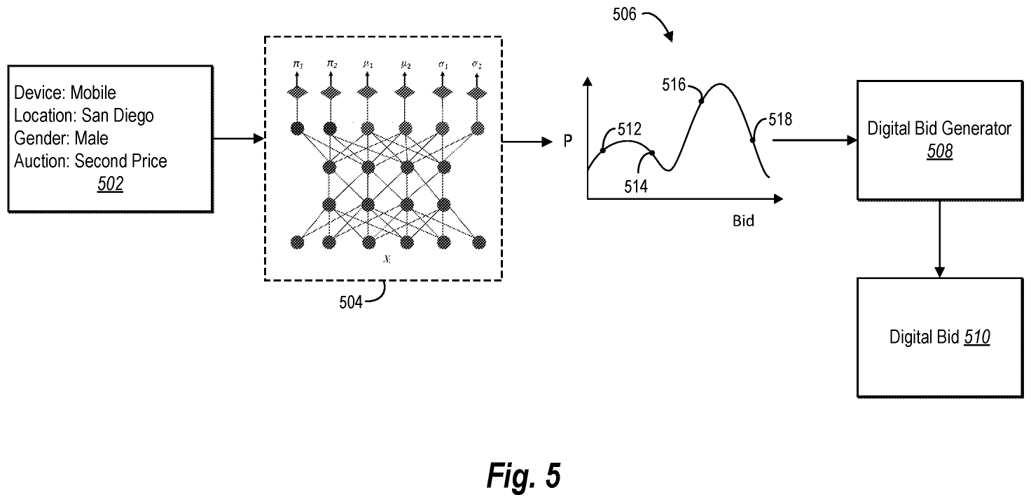

After training the parametric censored machine learning model, the parametric bid distribution system 106 can generate digital bids in response to receiving digital bid requests. FIG. 5 illustrates a block diagram of generating a digital bid in accordance with one or more embodiments. Though FIG. 5 illustrates generating a digital bid based on a parametric, multi-modal distribution generated by a parametric censored, mixture density machine learning model, it should be noted that the parametric bid distribution system 106 can similarly generate digital bids based on parametric bid distributions having only a parametric variance.

As shown in 5, the parametric bid distribution system 106 provides the digital bid request 502 having a set of bid request characteristics to the parametric censored, mixture density machine learning model 504 (e.g., a mixture density network as described in FIG. 4B). The parametric censored, mixture density machine learning model 504 uses the digital bid request 502 to generate the parametric, multi-modal distribution 506. The parametric bid distribution system 106 then uses a digital bid generator 508 to generate a digital bid 510 using the parametric, multi-modal distribution 506.

In one or more embodiments, the digital bid generator 508 generates the digital bid 510 by balancing the cost of the bid (i.e., the price the digital content administrator would pay if the bid is successful) with the probability of success utilizing the parametric, multi-modal distribution 506 in accordance with Equations 4 and 5. For example, the parametric, multi-modal distribution 506 may reveal two or more possible bids—such as the bids corresponding to the point 512 and the point 514—that have the same probability of success. The digital bid generator 508 can generate the digital bid 510 using the lower bid (i.e., the bid corresponding to the point 512). As another example, the parametric, multi-modal distribution 506 can reveal that one bid (e.g., the bid corresponding to the point 516) offers an increased probability of return (i.e., success) for a reduced cost when compared to another bid (e.g., the bid corresponding to the point 518). The digital bid generator 508 can generate the digital bid 510 based on the increased probability of return for the reduced cost.

In one or more embodiments, the digital bid generator 508 generates the digital bid 510 based on one or more campaign parameters or constraints. For example, a digital content administrator can access the parametric bid distribution system 106 using a client device to submit one or more parameters on how the parametric bid distribution system 106 is to generate digital bids. By way of example, and not limitation, campaign constraints can include a total campaign budget, an upper limit on the amount that can be offered in any particular bid, or the digital assets for which the parametric bid distribution system 106 can place bids.

Further, the parametric bid distribution system 106 can utilize the trained parametric censored machine learning model to generate parametric bid distributions in response to identifying digital bid request. The algorithms and acts described with references to FIGS. 1, 4A-4B, and/or 5 can comprise the corresponding structure for performing a step for utilizing the parametric censored machine learning model to generate a parametric bid distribution for a digital bid request.

As mentioned above, using a parametric censored machine learning model allows the parametric bid distribution system 106 to more accurately and efficiently generate bid distributions, which leads to better digital bids. Researchers have conducted several studies to determine the accuracy and effectiveness of one or more embodiments of the parametric bid distribution system 106.

The researchers compared both parametric and non-parametric methods of generating bid distributions. The parametric methods include the censored regression (CR) method (i.e., one approach taken by conventional systems that generate a point estimate) as well as the parametric censored regression (P-CR) and mixture density network censored regression (MDN-CR) approaches (i.e., the approaches described above in relation to the parametric bid distribution system 106). The non-parametric methods include the Kaplain-Meier (KM) estimate and the survival tree (ST) method (i.e., a decision-tree approach).

The researches also include a baseline by including the performance of a randomly picked winning price algorithm, referred to as the random strategy (RS). For this strategy, the maximum bid price is represented as z and the probability of success is represented as p. The probability that the winning price is w is given by:

$$\begin{matrix}Pr ( y = w ) = \frac{p}{z} if w ∈ [ 0 , z ] = 0 if w < 0 and & ( 26 ) \\ {\int }_{z}^{∞} Pr ( y = w ) d w = 1 - p & \end{matrix}$$

With probability of 1-p, equation 26 predicts the event that the winning price is greater than the max bid price. With probability p, it draws from [symbol] (0, z) where [symbol] is the uniform distribution.

The researchers had the objective of predicting the distribution of the winning price. The average negative log probability (ANLP) provides the accuracy of each method where a relatively lower ANLP value demonstrates relatively better accuracy. Equation 27 below defines the ANLP wherein [symbol] represents the set of winning bids, wᵢ represents the winning price of the i^{th} winning bid, [symbol] is the set of losing bids, bᵢ is the bidding price for the i^{th} losing bid, and | [symbol] |+| [symbol] |=N.

$$ANLP = - \frac{1}{N} ( {\sum }_{i ∈ 𝒲} log Pr ( {y}_{i} = {w}_{i} ) + {\sum }_{i ∈ ℒ} log Pr ( {y}_{i} \geq {b}_{i} ) ) \qquad ( 27 )$$

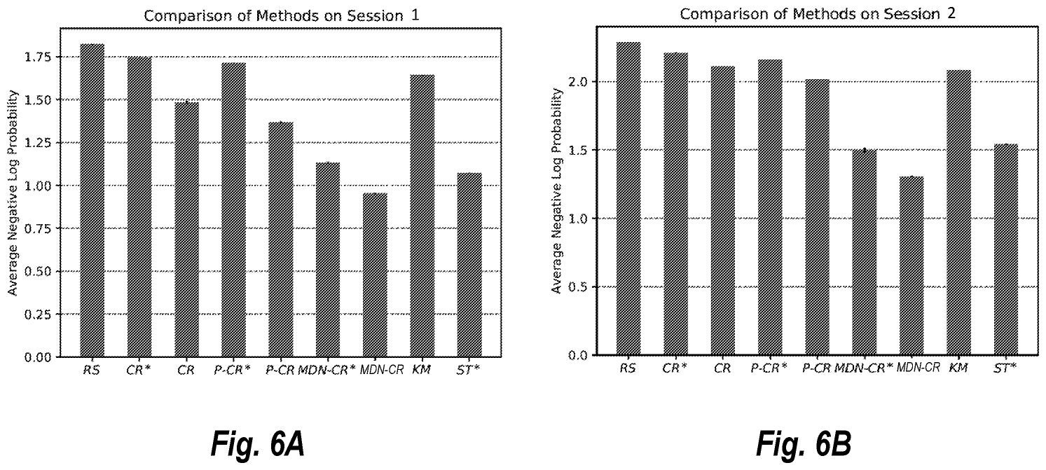

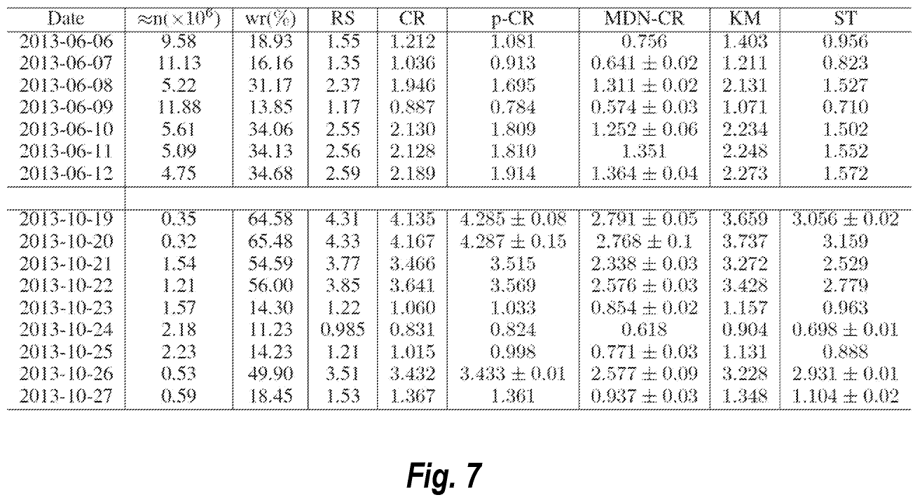

FIGS. 6A-6B illustrate a bar graph providing ANLP values for each method, using data from a publicly available dataset that was split into two different experimental sessions, with the results of the first session represented by FIG. 6A and the results of the second session represented by FIG. 6B. The error bar visible in parts of the graph represent the variance. In particular, FIGS. 6A & 6B represent approaches labeled as CR*, P-CR*, MDN-CR*, and ST*. This notation represents that a variant of the CR, P-CR, and MDN-CR methods were used in which feature trimming similar to that used for the ST method was implemented. In particular, feature trimming was implemented on the ST method for practical reasons based on the long runtime required to build a survival tree with a large feature space.

FIGS. 6A-6B show that P-CR is an improvement over the performance of the CR method. Further, the MDN-CR method performs better than any other tested method. Comparing performance of the P-CR and MDN-CR methods with the performance of their respective feature trimming variants shows better relatively improved performance by P-CR and MDN-CR. For example, MDN-CR* performs similarly to ST, but MDN-CR performs significantly better than ST. In particular, MDN-CR shows a ten percent improvement in both FIG. 6A and FIG. 6B. This highlights the scalability (i.e., flexibility) of the parametric bid distribution system 106, which performs particularly well in a large feature space.

FIG. 7 illustrates a table reflecting the ANLP values with the dataset separated into different calendar dates. The column labeled as “≈n(x 10⁶)” provides the sample size and the column labeled “wr(%)” provides the percentage of successful bids within the corresponding sample set. The table includes the value of the variance along with the ANLP value if the value of the variance is greater than 0.01.

Similar to FIGS. 6A-6B, the table of FIG. 7 shows that P-CR improves upon CR on most dates (except the low volume dates). As can be seen, P-CR shows an improvement around 5%-10%. Further, the table shows that MDN-CR improves upon CR by more than 30% on all dates. Thus, the table shows the improved accuracy of parametric bid distribution system 106 in using parametric bid distributions to generate digital bids.

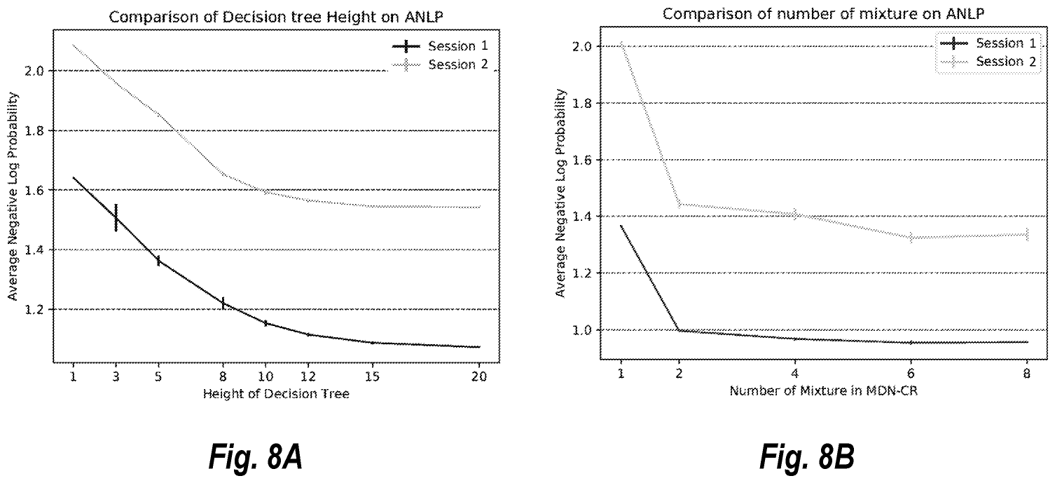

FIG. 8A illustrates a graph plotting the ANLP values of ST for different depths of the decision tree used in ST. In particular, the graph of FIG. 8A provides two plots, each representing one of experimental sessions discussed above with regard to FIGS. 6A-6B. As can be seen in FIG. 8A, both plots show that ST reaches its lowest ANLP values (i.e., it's most accurate performances) somewhere between depth 15 and depth 20. By contrast, FIG. 8B illustrates a graph plotting the ANLP values of MDN-CR for varying numbers of mixture components generated for the final parametric, multi-modal distribution. As can be seen in FIG. 8, both plots show that MDN-CR reaches its lowest ANLP values somewhere between 4 and 6 mixture components. Thus, a comparison of FIG. 8A and FIG. 8B reveals that the parametric bid distribution system 106, which implements MDN-CR, offers more efficient operation.

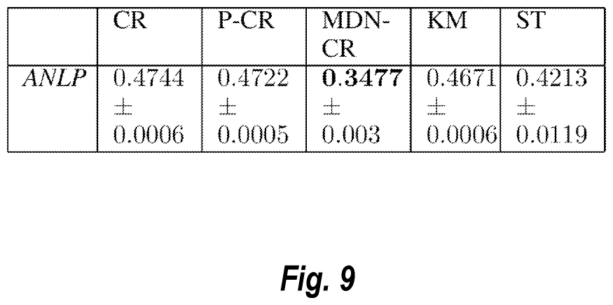

FIG. 9 illustrates a table reflecting performance of the tested methods using a dataset from a leading demand side platform. In particular, the data used to test the methods was sampled from a week's worth of data collected by the demand side platform. The table provides the ANLP values for each method. As can be seen by FIG. 9, MDN-CR improves CR by 25% while it improves ST by more than 10%. Thus, the table of FIG. 9 provides a further example of the improved accuracy of the parametric bid distribution system 106.

Turning now to FIG. 10, additional detail will be provided regarding various components and capabilities of the parametric bid distribution system 106. In particular, FIG. 10 illustrates the parametric bid distribution system 106 implemented by the computing device 1002 (e.g., the server(s) 102 as discussed above with reference to FIG. 1). Additionally, the parametric bid distribution system 106 is also part of the real-time digital bidding system 104. As shown, the parametric bid distribution system 106 can include, but is not limited to, a machine learning model training engine 1004, a machine learning model application manager 1006, a digital bid generator 1008, and data storage 1010 (which includes the training digital bid requests 1012, the machine learning model 1014, and the historical bid data 1016).

As just mentioned, and as illustrated by FIG. 10, the parametric bid distribution system 106 includes the machine learning model training engine 1004. In particular, the machine learning model training engine 1004 trains a parametric censored machine learning model to generate parametric bid distributions used in generating digital bids. In one or more embodiments, the machine learning model training engine 1004 trains a neural network to generate the parametric bid distributions. In some embodiments, the machine learning model training engine 1004 trains a parametric censored, mixture density machine learning model having a mixture density network architecture to generate parametric, multi-modal distributions. As an example, the machine learning model training engine 1004 can train the parametric censored machine learning model using the training digital bid requests 1012.

As shown in FIG. 10, the parametric bid distribution system 106 also includes the machine learning model application manager 1006. In particular, the machine learning model application manager 1006 uses the machine learning model trained by the machine learning model training engine 1004. For example, the machine learning model application manager 1006 can provide a digital bid request to a parametric censored machine learning model to generate a parametric bid distribution used for generating a digital bid. In some embodiments, the machine learning model application manager 1006 can provide a digital bid request to a parametric censored, mixture density machine learning model to generate a parametric, multi-modal distribution used for generating a digital bid.

Additionally, as shown in FIG. 10, the parametric bid distribution system 106 includes the digital bid generator 1008. In particular, the digital bid generator 1008 generates digital bids in response to a digital bid request. For example, the digital bid generator 1008 can use a parametric bid distribution provided by the machine learning model application manager 1006 to generate a digital bid. In one or more embodiments, the digital bid generator 1008 can use a parametric, multi-modal distribution provided by the machine learning model application manager 1006 to generate the digital bid.

Further, as shown in FIG. 10, the parametric bid distribution system 106 includes data storage 1010. In particular, data storage 1010 includes training digital bid requests 1012, machine learning model 1014, and historical bid data 1016. Training digital bid requests 1012 stores a plurality of training digital bid requests used in training machine learning models to generate parametric bid distributions. The machine learning model training engine 1004 can obtain the plurality of training digital bid requests from training digital bid requests 1012 when training the parametric censored machine learning model. Machine learning model 1014 stores the parametric censored machine learning model trained by the machine learning model training engine 1004 and applied by the machine learning model application manager 1006. Historical bid data 1016 stores the digital bids corresponding to the training digital bid requests.

Each of the components 1004-1016 of the parametric bid distribution system 106 can include software, hardware, or both. For example, the components 1004-1016 can include one or more instructions stored on a computer-readable storage medium and executable by processors of one or more computing devices, such as a client device or server device. When executed by the one or more processors, the computer-executable instructions of the parametric bid distribution system 106 can cause the computing device(s) to perform the methods described herein. Alternatively, the components 1004-1016 can include hardware, such as a special-purpose processing device to perform a certain function or group of functions. Alternatively, the components 1004-1016 of the parametric bid distribution system 106 can include a combination of computer-executable instructions and hardware.

Furthermore, the components 1004-1016 of the parametric bid distribution system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1004-1016 of the parametric bid distribution system 106 may be implemented as a stand-alone application, such as a desktop application. Furthermore, the components 1004-1016 of the parametric bid distribution system 106 may be implemented as one or more web-based applications hosted on a remote server. Alternatively, or additionally, the components 1004-1016 of the parametric bid distribution system 106 may be implemented in a suite of mobile device applications or “apps.” For example, in one or more embodiments, the query-time attribution system can comprise or operate in connection with digital software applications such as ADOBE® ANALYTICS CLOUD® or ADOBE® MARKETING CLOUD®. “ADOBE,” “ANALYTICS CLOUD,” and “MARKETING CLOUD” are either registered trademarks or trademarks of Adobe Inc. in the United States and/or other countries.

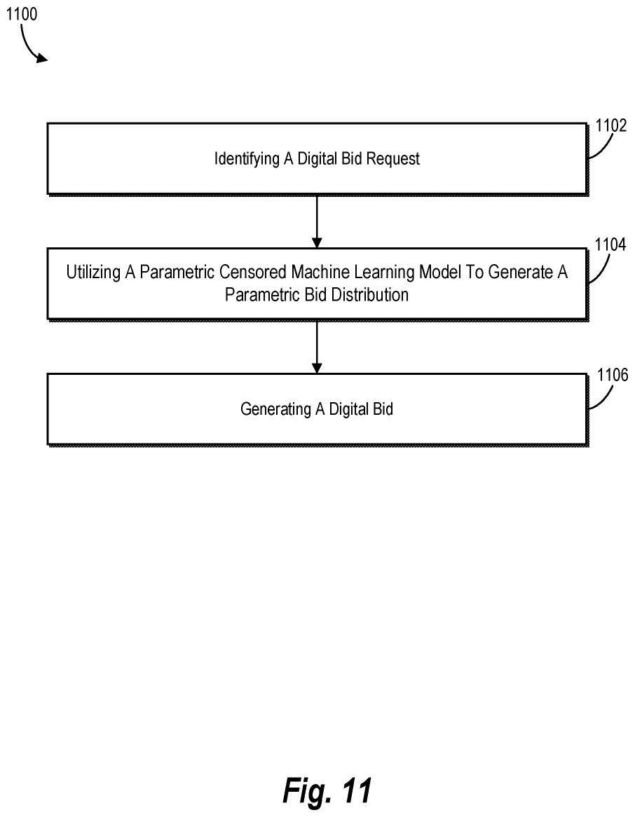

FIGS. 1-10, the corresponding text, and the examples provide a number of different methods, systems, devices, and non-transitory computer-readable media of the parametric bid distribution system 106. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

As mentioned, FIG. 11 illustrates a flowchart of a series of acts 1100 for generating a digital bid in response to identifying a digital bid request. While FIG. 11 illustrates acts according to one embodiment, alternative embodiments may omit, add to, reorder, and/or modify any of the acts shown in FIG. 11. The acts of FIG. 11 can be performed as part of a method. Alternatively, a non-transitory computer-readable medium can comprise instructions that, when executed by one or more processors, cause a computing device to perform the acts of FIG. 11. In some embodiments, a system can perform the acts of FIG. 11.

The series of acts 1100 includes an act 1102 of identifying a digital bid request. For example, the act 1102 involves identifying a digital bid request for providing digital content to a remote client device accessing a digital asset via a remote server. In one or more embodiments, identifying the digital bid request comprises identifying bid request characteristics comprising at least one of a client device type, a client device location, a user gender, a user age, a publisher, publisher verticals, or digital auction type.

The series of acts 1100 also includes an act 1104 of utilizing a parametric censored machine learning model to generate a parametric bid distribution. For example, the act 1104 involves in response to identifying the digital bid request, and while the remote client device is accessing the digital asset via the remote server, utilizing a parametric censored machine learning model to generate a parametric bid distribution comprising a parametric variance based on the digital bid request. Specifically, the parametric censored machine learning model is trained based on training bid requests, training bids, and corresponding training real-time bid results to generate parametric distributions with parametric variances that change based on different bid request characteristics. In one or more embodiments, the parametric censored machine learning model comprises a neural network.

In one or more embodiments, the parametric censored machine learning model comprises a parametric censored, mixture density machine learning model trained to generate parametric, multi-modal distributions. Specifically, in one or more embodiments, the parametric bid distribution comprises a parametric, multi-modal bid distribution comprising a plurality of parametric means, a plurality of parametric variances, and a plurality of mixture weights. In other words, the parametric bid distribution system 106 can utilize the parametric censored, mixture density machine learning model to generate a parametric, multi-modal bid distribution (i.e., generate a plurality of parametric variances, a plurality of parametric means, and a plurality of mixture weights). In one or more embodiments, the plurality of parametric variances comprises at least four parametric variances. In some embodiments, the plurality of parametric variances comprises a first parametric variance and a second parametric variance having a different value than the first parametric variance.

The series of acts 1100 further includes an act 1106 of generating a digital bid. For example, the act 1106 involves generating a digital bid for providing the digital content to the remote client device based on the parametric bid distribution. In one or more embodiments, generating the digital bid includes utilizing the parametric bid distribution to identify an increased probability of return for a reduced cost and generating the digital bid based on the increased probability of return for the reduced cost.

In one or more embodiments, the series of acts 1100 further includes acts for generating a second digital bid in response to identifying a second digital bid request. For example, the acts can include identifying a second digital bid request for providing digital content to a second remote client device accessing the digital asset via the remote server; in response to identifying the second digital bid request, and while the second remote client device is accessing the digital asset via the remote server, utilizing the parametric censored machine learning model to generate a second parametric bid distribution comprising a second parametric variance based on the second digital bid request, the second parametric variance having a different value than the parametric variance; and generate a second digital bid for providing the digital content to the second remote client device based on the second parametric bid distribution.

In some embodiments, the series of acts 1100 further include acts for training a parametric censored machine learning model. For example, the acts can include training a parametric censored, mixture density machine learning model to generate bid distributions for bid requests by analyzing a training bid request utilizing the parametric censored, mixture density machine learning model to generate a predicted parametric, multi-modal distribution, wherein the predicted parametric, multi-modal distribution comprises a plurality of predicted parametric variances, a plurality of predicted parametric means, and a plurality of predicted mixture weights; and modifying the parametric censored, mixture density machine learning model by comparing the plurality of predicted parametric variances, the plurality of predicted parametric means, and the plurality of predicted mixture weights with a training real-time bidding result corresponding to the training bid request. In one or more embodiments, the parametric censored, mixture density machine learning model comprises a neural network. In some embodiments, based on comparing the plurality of predicted parametric variances, the plurality of predicted parametric means, and the plurality of predicted mixture weights with the training real-time bidding result corresponding to the training bid request, the parametric bid distribution system 106 modifies internal parameters of the parametric censored, mixture density machine learning model using a loss function.

In one or more embodiments, the plurality of predicted parametric means comprises a first predicted parametric mean for a first predicted distribution and a second predicted parametric mean for a second predicted distribution; the plurality of predicted parametric variances comprises a first predicted parametric variance for the first predicted distribution and a second predicted parametric variance for the second predicted distribution; the plurality of mixture weights comprises a first mixture weight corresponding to the first predicted distribution and a second mixture weight corresponding to the second predicted distribution; and the parametric bid distribution system 106 generates the predicted parametric, multi-modal distribution by combining the first predicted distribution and the second predicted distribution based on the first mixture weight and the second mixture weight. In some embodiments, the plurality of predicted parametric variances comprises a first predicted parametric variance and a second predicted parametric variance having a different value than the first predicted parametric variance.

The series of acts 1100 can further include acts for using the trained parametric censored, mixture density machine learning model. For example, the acts can include identifying a digital bid request for providing digital content to a remote client device accessing a digital asset via a remote server; in response to identifying the digital bid request, utilizing the trained parametric censored, mixture density machine learning model to generate a parametric, multi-modal distribution; and generating a digital bid for providing the digital content to the remote client device based on the parametric, multi-modal distribution. In one or more embodiments, generating the digital bid includes utilizing the parametric, multi-modal distribution to identify an increased probability of return for a reduced cost and generating the digital bid based on the increased probability of return for the reduced cost.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., the server(s) 102, client devices 118a-118n, and the digital content administrator device 112). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. In a real-time digital bidding environment for distributing digital content to client devices over a network as client devices access digital assets from a remote server, a computer-implemented method for accurately and flexibly generating and transmitting real-time digital bids based on parametric bid distributions comprising:
performing a step for training a parametric censored machine learning model to generate parametric bid distributions for digital bid requests;
identifying a digital bid request for providing digital content to a remote client device;
performing a step for utilizing the parametric censored machine learning model to generate a parametric bid distribution for the digital bid request; and
generating a digital bid for providing the digital content to the remote client device based on the parametric bid distribution.

2. The method of claim 1, wherein the parametric censored machine learning model comprises a parametric censored, mixture density machine learning model trained to generate parametric, multi-modal distributions.

3. The method of claim 2, wherein the parametric bid distribution comprises a parametric, multi-modal bid distribution comprising a plurality of parametric means, a plurality of parametric variances, and a plurality of mixture weights.

4. The method of claim 1, wherein identifying the digital bid request comprises identifying bid request characteristics comprising at least one of a client device type, a client device location, a user gender, a user age, a publisher, publisher verticals, or digital auction type.

5. A non-transitory computer readable storage medium comprising instructions that, when executed by at least one processor, cause a computing device to:
identify a digital bid request for providing digital content to a remote client device accessing a digital asset via a remote server;
in response to identifying the digital bid request, and while the remote client device is accessing the digital asset via the remote server:
utilize a parametric censored machine learning model to generate a parametric bid distribution comprising a parametric variance based on the digital bid request,
wherein the parametric censored machine learning model is trained based on training bid requests, training bids, and corresponding training real-time bid results to generate parametric distributions with parametric variances that change based on different bid request characteristics; and
generate a digital bid for providing the digital content to the remote client device based on the parametric bid distribution.

6. The non-transitory computer readable storage medium of claim 5, wherein:
the parametric censored machine learning model comprises a parametric censored, mixture density machine learning model trained to generate parametric, multi-modal distributions, and
the instructions, when executed by the at least one processor, cause the computing device to utilize the parametric censored machine learning model to generate the parametric bid distribution by utilizing the parametric censored, mixture density machine learning model to generate a parametric, multi-modal bid distribution.

7. The non-transitory computer readable storage medium of claim 6, wherein utilizing the parametric censored, mixture density machine learning model to generate the parametric, multi-modal bid distribution comprises utilizing the parametric censored, mixture density machine learning model to generate a plurality of parametric variances, a plurality of parametric means, and a plurality of mixture weights.

8. The non-transitory computer readable storage medium of claim 7, wherein the plurality of parametric variances comprises at least four parametric variances.

9. The non-transitory computer readable storage medium of claim 7, wherein the plurality of parametric variances comprises a first parametric variance and a second parametric variance having a different value than the first parametric variance.

10. The non-transitory computer readable storage medium of claim 5, wherein the instructions, when executed by the at least one processor, cause the computing device to generate the digital bid for providing the digital content to the remote client device based on the parametric bid distribution by:
utilizing the parametric bid distribution to identify an increased probability of return for a reduced cost; and
generating the digital bid based on the increased probability of return for the reduced cost.

11. The non-transitory computer readable storage medium of claim 5, wherein the parametric censored machine learning model comprises a neural network.

12. The non-transitory computer readable storage medium of claim 5, further comprising instructions that, when executed by the at least one processor, cause the computing device to:
identify a second digital bid request for providing digital content to a second remote client device accessing the digital asset via the remote server;
in response to identifying the second digital bid request, and while the second remote client device is accessing the digital asset via the remote server:
utilize the parametric censored machine learning model to generate a second parametric bid distribution comprising a second parametric variance based on the second digital bid request, the second parametric variance having a different value than the parametric variance; and
generate a second digital bid for providing the digital content to the second remote client device based on the second parametric bid distribution.

13. The non-transitory computer readable storage medium of claim 5, wherein the instructions, when executed by the at least one processor, cause the computing device to identify the digital bid request by identifying bid request characteristics comprising at least one of a client device type, a client device location, a user gender, a user age, a publisher, publisher verticals, or digital auction type.

14. A system comprising:
at least one processor;
at least one non-transitory computer readable storage medium storing instructions that, when executed by the at least one processor, cause the system to:
train a parametric censored, mixture density machine learning model to generate bid distributions for bid requests by:
analyzing a training bid request utilizing the parametric censored, mixture density machine learning model to generate a predicted parametric, multi-modal distribution,
wherein the predicted parametric, multi-modal distribution comprises a plurality of predicted parametric variances, a plurality of predicted parametric means, and a plurality of predicted mixture weights; and
modify the parametric censored, mixture density machine learning model by comparing the plurality of predicted parametric variances, the plurality of predicted parametric means, and the plurality of predicted mixture weights with a training real-time bidding result corresponding to the training bid request.

15. The system of claim 14, further comprising instructions that, when executed by the at least one processor, cause the system to, based on comparing the plurality of predicted parametric variances, the plurality of predicted parametric means, and the plurality of predicted mixture weights with the training real-time bidding result corresponding to the training bid request, modify internal parameters of the parametric censored, mixture density machine learning model using a loss function.

16. The system of claim 14, wherein:
the plurality of predicted parametric means comprises a first predicted parametric mean for a first predicted distribution and a second predicted parametric mean for a second predicted distribution,
the plurality of predicted parametric variances comprises a first predicted parametric variance for the first predicted distribution and a second predicted parametric variance for the second predicted distribution,
the plurality of predicted mixture weights comprises a first predicted mixture weight corresponding to the first predicted distribution and a second predicted mixture weight corresponding to the second predicted distribution,
the instructions, when executed by the at least one processor, cause the system to generate the predicted parametric, multi-modal distribution by combining the first predicted distribution and the second predicted distribution based on the first mixture weight and the second mixture weight.

17. The system of claim 14, wherein the parametric censored, mixture density machine learning model comprises a neural network.

18. The system of claim 14, wherein the plurality of predicted parametric variances comprises a first predicted parametric variance and a second predicted parametric variance having a different value than the first predicted parametric variance.

19. The system of claim 14, further comprising instructions that, when executed by the at least one processor, cause the system to:
identify a digital bid request for providing digital content to a remote client device accessing a digital asset via a remote server;
in response to identifying the digital bid request, utilize the trained parametric censored, mixture density machine learning model to generate a parametric, multi-modal distribution; and
generate a digital bid for providing the digital content to the remote client device based on the parametric, multi-modal distribution.

20. The system of claim 19, wherein the instructions, when executed by the at least one processor, cause the system to generate the digital bid for providing the digital content to the remote client device based on the parametric, multi-modal distribution by:
utilizing the parametric, multi-modal distribution to identify an increased probability of return for a reduced cost; and
generating the digital bid based on the increased probability of return for the reduced cost.
